(19) United States
(12) Patent Application Publication
(10) Pub. No.: US 2024/0296591 A1
(43) Pub. Date: Sep. 5, 2024

(54) METHOD AND APPARATUS FOR LIDAR POINT CLOUD CODING USING POINTWISE PREDICITON

(71) Applicants: HYUNDAI MOTOR COMPANY, Seoul (KR); KIA CORPORATION, Seoul (KR); DIGITALINSIGHTS INC., Seoul (KR)

(72) Inventors: Yong Jo Ahn, Seoul (KR); Jong Seok Lee, Seoul (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); DIGITALINSIGHTS INC., Seoul (KR)

(21) Appl. No.: 18/665,041

(22) Filed: May 15, 2024

Related U.S. Application Data
(63) Continuation of application No. PCT/KR2022/014173, filed on Sep. 22, 2022.

(30) Foreign Application Priority Data
Nov. 19, 2021 (KR) 10-2021-0160574
Sep. 21, 2022 (KR) 10-2022-0119086

(51) Int. Cl. G06T 9/00

(52) U.S. Cl. CPC G06T 9/001

(57) ABSTRACT

A LiDAR point cloud coding method and a device use pointwise prediction. The point cloud coding method and the device predict a current point to be encoded/decoded by using a previously decoded point cloud to improve the coding efficiency of LiDAR point cloud coding.

### CROSS-REFERENCE TO RELATED APPLICATIONS

This application is a continuation of International Application No. PCT/KR2022/014173 filed on Sep. 22, 2022, which claims priority to and the benefit of Korean Patent Application No. 10-2021-0160574, filed on Nov. 19, 2021, and Korean Patent Application No. 10-2022-0119086, filed on Sep. 21, 2022, the entire disclosures of each of which are incorporated herein by reference.

### TECHNICAL FIELD

The present disclosure relates to a method and an apparatus for LiDAR point cloud coding using pointwise prediction.

### BACKGROUND

The statements in this section merely provide background information related to the present disclosure and do not necessarily constitute prior art.

Conventional point cloud compression technology performs encoding and decoding on points obtained over a certain period. High-speed acquisition, high-speed compression, and high-speed transmission are required for point clouds acquired from LiDAR depending on the specific application. To this end, encoding/decoding may be performed on a point-by-point basis, for which a First-In-First-Out (FIFO) buffer may be used to store encoded points for use in encoding the subsequent points. Additionally, to improve the efficiency of point cloud coding, the coding method of the points needs to be improved.

### SUMMARY

The present disclosure seeks to provide a point cloud coding method and a device for predicting a point to be currently encoded/decoded using a previously decoded point cloud to improve the coding efficiency of LiDAR point cloud coding.

At least one aspect of the present disclosure provides a method performed by a point cloud decoding device for decoding a current point. The method includes decoding, from a bitstream, a quantized residual point, a quantization parameter, a prediction candidate list index, and a predictor index. The method also includes reconstructing a residual point by dequantizing the quantized residual point by using the quantization parameter. The method also includes determining a prediction candidate list according to the prediction candidate list index. The method also includes determining a predicted point from the prediction candidate list by using the predictor index. The method also includes reconstructing the current point by adding the residual point and the predicted point and storing a reconstructed current point in a buffer.

Another aspect of the present disclosure provides a method performed by a point cloud encoding device for encoding a current point. The method includes obtaining the current point and determining a prediction candidate list index and a predictor index. The method also includes determining a prediction candidate list according to the prediction candidate list index and determining a predicted point from the prediction candidate list by using the predictor index. The method also includes generating a residual point by subtracting the predicted point from the current point. The method also includes determining a quantization parameter and quantizing the residual point by using the quantization parameter. The method also includes generating a bitstream by encoding a quantized residual point, the prediction candidate list index, the predictor index, and the quantization parameter.

Yet another aspect of the present disclosure provides a computer-readable recording medium storing a bitstream generated by a point cloud encoding method. The point cloud encoding method includes obtaining a current point and determining a prediction candidate list index and a predictor index. The point cloud encoding method also includes determining a prediction candidate list according to the prediction candidate list index and determining a predicted point from the prediction candidate list by using the predictor index. The point cloud encoding method also includes generating a residual point by subtracting the predicted point from the current point. The point cloud encoding method also includes determining a quantization parameter and quantizing the residual point by using the quantization parameter. The point cloud encoding method also includes generating a bitstream by encoding a quantized residual point, the prediction candidate list index, the predictor index, and the quantization parameter.

As described above, the present disclosure provides a point cloud coding method and a device for predicting a point to be currently encoded/decoded using a previously decoded point cloud. Thus, the point cloud coding method and the device may eliminate redundancy in space and time within a LiDAR point cloud to improve the coding efficiency thereof.

### BRIEF DESCRIPTION OF THE DRAWINGS

FIG. 1 is a block diagram of a point cloud encoding device according to at least one embodiment of the present disclosure.

FIG. 2 is a block diagram of a point cloud decoding device according to at least one embodiment of the present disclosure.

FIG. 3 is a diagram illustrating the encoding/decoding order of a point cloud with geometric information expressed in a cylindrical coordinate system, according to at least one embodiment of the present disclosure.

FIG. 4 is a diagram illustrating point prediction using a prediction candidate list, according to at least one embodiment of the present disclosure.

FIG. 5 is a diagram illustrating point prediction using two prediction candidate lists, according to at least one embodiment of the present disclosure.

FIG. 6 is a flowchart of a method of encoding a LiDAR point cloud, according to at least one embodiment of the present disclosure.

FIG. 7 is a flowchart of a method of decoding a LiDAR point cloud, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

Embodiments of the present disclosure relates to a method and a device for LiDAR point cloud coding. More specifically, a point cloud coding method and a device are provided for predicting a point to be currently encoded/decoded using a previously decoded point cloud.

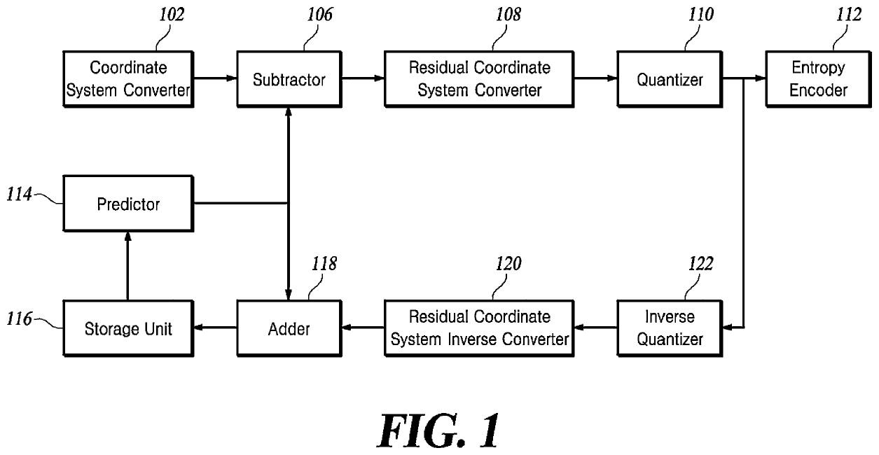

FIG. 1 is a block diagram of a point cloud encoding device according to at least one embodiment of the present disclosure.

The point cloud encoding device (hereinafter, used interchangeably with ‘encoding device’) according to this embodiment uses the prediction of the current point based on a previously decoded point cloud to encode the current point. The encoding device may include all or part of a coordinate system converter 102, a subtractor 106, a residual coordinate system converter 108, a quantizer 110, an entropy encoder 112, a predictor 114, a storage unit 116, an adder 118, a residual coordinate system inverse converter 120, and an inverse quantizer 122.

The coordinate system converter 102 obtains a point cloud over some time. The point cloud may include points each having geometric information indicating the location of each point and may include attribute information indicating a value of the point. The geometric information of the point may have a different coordinate system depending on the output format of the LiDAR. For example, a cylindrical LiDAR may generally obtain a point cloud using a cylindrical coordinate system. Alternatively, a rectangular, plate-type LiDAR may use a Cartesian coordinate system. Therefore, a point cloud may need a conversion of the coordinate system of the geometric information from the coordinate system of the point cloud to the coordinate system used inside the encoding device. The coordinate system converter 102 converts the coordinate system to suit the encoding device and then transmits the converted point to the subtractor 106.

Meanwhile, each point in the point cloud may have different attribute information depending on the LiDAR. For example, because the most common LiDAR measures a reflection coefficient, the attribute information may include a reflection coefficient value. The reflection coefficient varies depending on the surface properties of the object, so the same object may have similar reflection coefficients. As another example, if the LiDAR incorporates CCD sensors in addition to multiple lasers, the attribute information may include color information from multiple channels, such as RGB, YCbCr, YCoCg, and the like.

The predictor 114 may generate a predicted point by predicting the current point by using stored reconstructed points. The generated predicted point may be transmitted to the subtractor 106 and the adder 118. For high-speed encoding, the predictor 114 may predict the current point by using only a certain number of recently encoded points. At this time, the maximum number of points to be used for prediction may be encoded by the entropy encoder 104 and then transmitted to a point cloud decoding device.

Additionally, the current point may be predicted by using points that are spatially adjacent to the current point. Spatially adjacent points may be determined based on the geometric information of the current point and previously reconstructed points. Alternatively, the predictor 114 may determine which points to use among temporally adjacent points and spatially adjacent points, and then the predictor 114 may use the determined points for prediction. The flag for this decision may be encoded by the entropy encoder 104 and then transmitted to the point cloud decoding device.

Alternatively, the predictor 114 may distinguish points to be used for prediction and store the points for use in the subsequent prediction. The number of points to be stored may be encoded by the entropy encoder 104 and then transmitted to the point cloud decoding device.

Meanwhile, the predictor 114 may perform prediction on some points in the point cloud that are included in the background or background-equivalent objects. In other words, the predictor 114 may skip prediction on the points included in the foreground or foreground-equivalent objects. A flag indicating whether or not prediction is to be applied to each point may be signaled by the encoding device to the point cloud decoding device.

The subtractor 106 may subtract the predicted point from the current point to generate a residual point. The subtractor 106 may apply subtraction to both geometric information and attribute information when generating the residual point. At this time, an offset may be added for the distance between the previous point and the current point, and then subtraction may be applied to the geometric information. The subtractor 106 may transmit the residual point to the residual coordinate system converter 108. The predicted point may be transmitted from the predictor 114.

The residual coordinate system converter 108 may convert the coordinate system of the residual point into a coordinate system that is efficient in terms of encoding. At this time, with respect to the geometric information of the residual point, the coordinate system exclusive to the residual values may be converted. Alternatively, the residual values of the geometric information may be coordinate system-converted. Based on the converted geometric information, the attribute information of the residual point may be recalculated or filtered, and thus the attribute information may be corrected. The coordinate system-converted residual point may be transmitted to the quantizer 110. At this time, information for a residual coordinate system conversion may be encoded by the entropy encoder 112 and then transmitted to the point cloud decoding device.

The quantizer 110 may quantize the residual point by using a quantization parameter and then may transmit the quantized point to the entropy encoder 112 and the inverse quantizer 122. The quantization parameter may be determined in terms of optimizing coding efficiency. Meanwhile, the quantizer 110 may separately perform quantization on the geometric information and the attribute information. To this end, separate quantization parameters may be used for the geometric information and the attribute information. The quantization parameter may be encoded by the entropy encoder 112 and then transmitted to the point cloud decoding device. Alternatively, the encoding device may determine a flag indicating whether to use the same quantization parameter for the geometric information and the attribute information and then may transmit the determined flag to the point cloud decoding device. The point cloud decoding device may decode that flag and then may reconstruct either one or both quantization parameters based on that flag.

The entropy encoder 112 may entropy encode the quantized residual point to generate a bitstream. Alternatively, for high-speed processing, the entropy encoder 112 may skip encoding and instead may perform packing encoding information in byte units to generate a bitstream. Alternatively, for entropy encoding, arithmetic encoding may be used based on multiple symbols that are adaptive to the context. Alternatively, Context Adaptive Binary Arithmetic Coding (CABAC) may be used to encode the quantized residual point. Alternatively, an entropy encoding method such as Huffman coding may be used. Alternatively, a deep neural network trained by using a large number of training data may be used.

The entropy encoder 112 may encode parameters related to the encoding of points and may add the encoded parameters to the bitstream. Here, the parameters include the flag indicating whether to apply prediction, the quantization parameter, and the information for the residual coordinate system conversion. Depending on the encoding method of the point, the parameters may include additional information, which is described below.

The inverse quantizer 122 may inversely quantize the quantized residual point by using the quantization parameter to reconstruct the residual point. The reconstructed residual point may be transmitted to the residual coordinate system inverse converter 120.

The residual coordinate system inverse converter 120 may inversely convert the coordinate system of the geometric information for the reconstructed residual point and then may transmit the coordinate system inversely-converted coordinate system to the adder 118.

The adder 118 may add the coordinate system inversely-converted residual point and the predicted point received from the predictor 114 to reconstruct the current point. The reconstructed point may be transmitted to the storage unit 116.

The storage unit 116 may store the reconstructed point in a buffer. The storage unit 116 may transmit one or multiple stored points to the predictor 114.

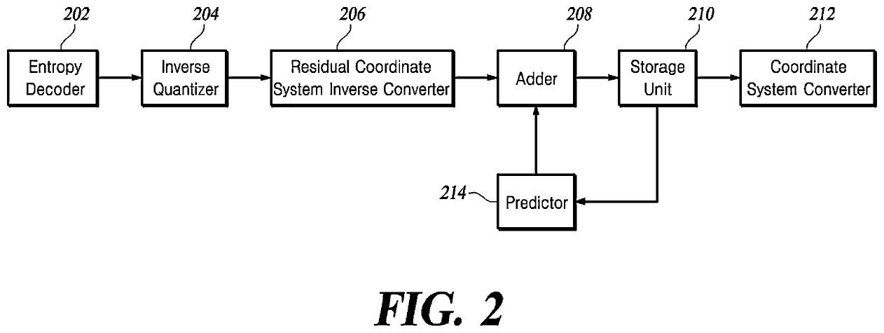

FIG. 2 is a block diagram of a point cloud decoding device according to at least one embodiment of the present disclosure.

The point cloud decoding device (hereinafter, used interchangeably with ‘decoding device’) according to this embodiment decodes points to generate a LiDAR point cloud. The decoding device includes all or part of an entropy decoder 202, an inverse quantizer 204, a residual coordinate system inverse converter 206, an adder 208, a storage unit 210, a coordinate system converter 212, and a predictor 214.

The entropy decoder 202 may entropy decode the bitstream received from the encoding device to generate a quantized residual point. The generated residual point may be transmitted to the inverse quantizer 204. Additionally, the entropy decoder 202 decodes various parameters used in the encoding device to be conditioned for use in the decoding device. The parameters include, for example, the quantization parameter(s), the information for the residual coordinate system conversion, and the like. Other information items that the parameters contain are described below.

The inverse quantizer 204 may inversely quantize the quantized residual point by using the quantization parameter to reconstruct the residual point. The reconstructed residual point may be transmitted to the residual coordinate system inverse converter 206.

The residual coordinate system inverse converter 206 may inversely convert the coordinate system of the geometric information for the received reconstructed residual point by using the information for the residual coordinate system conversion. The inversely converted residual point may be transmitted to the adder 208.

The predictor 214 may predict the current point by using the stored reconstructed points to generate a predicted point. The generated predicted point may be transmitted to the adder 208.

In the manner described above, the predictor 214 may perform prediction on some points in the point cloud that are included in the background or background-equivalent objects. The predictor 214 may determine whether to make predictions for each point based on the flag indicating whether or not prediction is to be applied, which is delivered by the encoding device.

The adder 208 may add the coordinate system inversely-converted residual point and the predicted point received from the predictor 214 to reconstruct the current point. The reconstructed point may be transmitted to the storage unit 210.

The storage unit 210 may store the reconstructed point in a buffer. The stored points may be transmitted to the predictor 214 for reconstruction of the subsequent points. Additionally, the stored point cloud may be transmitted to the coordinate system converter 212 for outputting thereof.

The coordinate system converter 212 may perform coordinate system conversion to output the stored points. At this time, the coordinate system converter 212 may convert the coordinate system exclusive to geometric information for the frame of the point cloud, from the internal coordinate system of the decoding device to the world coordinate system.

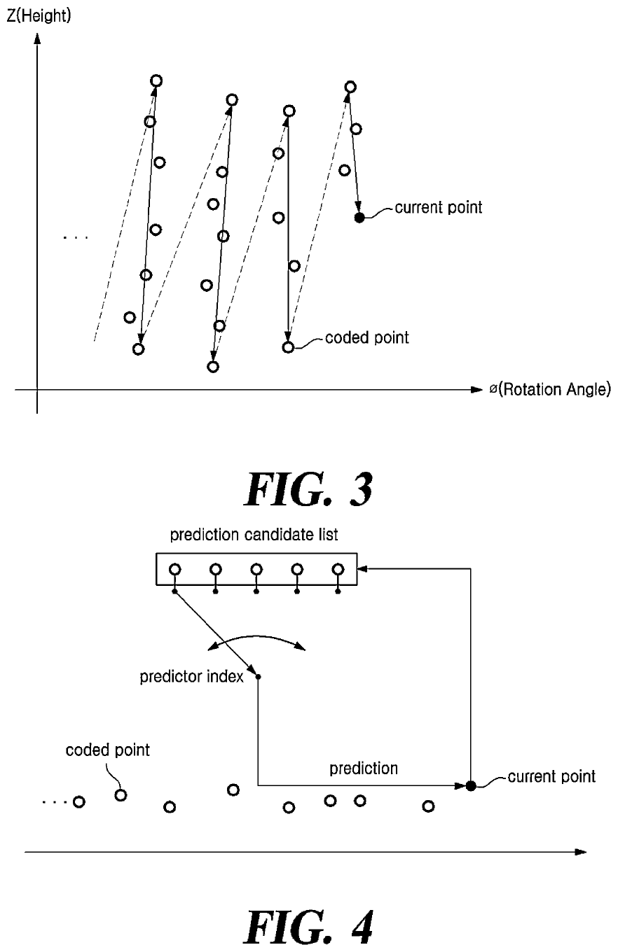

FIG. 3 is a diagram illustrating the encoding/decoding order of a point cloud with geometric information expressed in a cylindrical coordinate system, according to at least one embodiment of the present disclosure.

In general, a point cloud with geometric information expressed in a cylindrical coordinate system may be generated by a cylindrical LiDAR including a specific number of vertical lasers. At this time, the vertical lasers as rotated may acquire points. When the geometric information of the acquired points is projected from the cylindrical coordinate system to a plane expressed by the rotation angle and height, projected points may be expressed as illustrated in FIG. 3. Here, the height may be determined by the number of lasers. The encoding/decoding order of the respective points may be the order indicated by arrows, as illustrated in FIG. 3. Since the LiDAR acquires points as the LiDAR rotates, the points may be obtained by moving to the right around the rotation axis of the LiDAR. When high-speed encoding/decoding is required, the points may be sequentially encoded/decoded in that order as illustrated in FIG. 3.

FIG. 4 is a diagram illustrating point prediction using a prediction candidate list, according to at least one embodiment of the present disclosure.

The encoding device or the decoding device may sequentially encode/decode points according to their acquisition time. The encoding device or the decoding device may store information on the encoded points and use a prediction candidate list to predict the current point. The encoding device may generate a predicted point by selecting the point most similar to the current point from the prediction candidate list. Additionally, the encoding device may encode a predictor index inside the prediction candidate list for the selected point and then may transmit the predictor index to the decoding device. Upon receiving the predictor index, the decoding device may select the point corresponding to its number from the prediction candidate list to generate the predicted point.

The encoding device or the decoding device may update the prediction candidate list by using the reconstructed current point. For example, if the reconstructed current point is obtained from a different object from the objects containing points as included in the candidate list, the reconstructed current point may be added to the foremost of the list, and the last candidate in the list may be removed. On the other hand, if the reconstructed current point is obtained from the same object as one of the objects containing the points included in the candidate list, the point most similar to the reconstructed current point may be removed from the list, and the reconstructed current point may be added to the foremost of the list.

At this time, whether the points are obtained from the same object may be determined according to geometric information. For example, points in spatially proximate locations may be determined to have been obtained from the same object. Alternatively, whether points are obtained from the same object may be determined according to attribute information. For example, if the attribute information includes a reflection coefficient, the reflection coefficients may be compared to confirm whether the points are reflected from the surface of the same object. Alternatively, when attribute information includes color information, whether points are obtained from the same object may be determined based on differences in color information. The encoding device or the decoding device may use the updated candidate list to predict the subsequent point.

Hereinafter, the list that includes points similar to the current point and is updated by using the reconstructed current point is referred to as the first prediction candidate list.

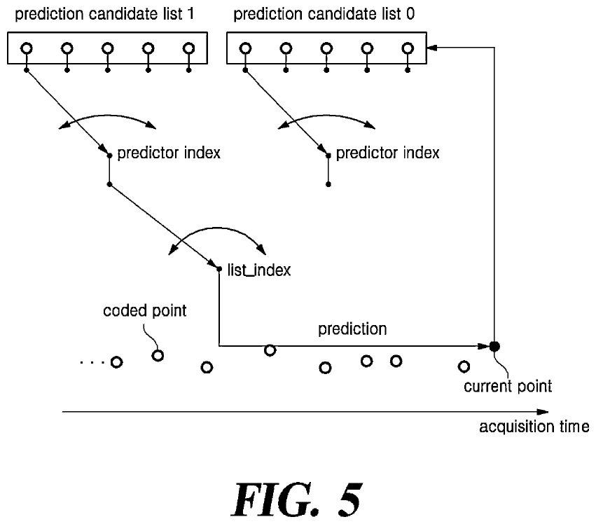

FIG. 5 is a diagram illustrating point prediction using two prediction candidate lists, according to at least one embodiment of the present disclosure.

As described above, the encoding device or the decoding device may encode/decode points in the LiDAR point cloud according to acquisition time. The encoding device or the decoding device can improve coding efficiency by predicting the current point by using two prediction candidate lists. The two different prediction candidate lists may be used for different purposes. As illustrated in FIG. 5, upon completion of the encoding/decoding of the current point, the encoding device or the decoding device may update the first prediction candidate list (prediction candidate list 0), and when predicting each point, it may newly generate the second prediction candidate list (prediction candidate list 1).

As described above, since temporally adjacent points may be stored in the first prediction candidate list, the encoding device or the decoding device may use the first prediction candidate list to perform prediction based on temporal redundancy. Additionally, since spatially adjacent points may be stored in the first prediction candidate list, the encoding device or the decoding device may use the first prediction candidate list to perform prediction based on spatial redundancy.

The second prediction candidate list may be constructed according to various methods. For example, values estimated from LiDAR parameters representing characteristics of LiDAR sensors may be used to construct the second prediction candidate list. For example, after predicting the quantized current point and its location by using LiDAR parameters and after searching for, among the reconstructed points, points closest to the quantized current point in terms of distance, a preset number of the searched points may be used to compose the second prediction candidate list. Alternatively, after searching for points included in the previous frame for sharing the same location with and being spatially adjacent to the quantized current point, a preset number of the searched points may be used to compose the second prediction candidate list. Here, a frame represents a point cloud acquired during a specific time. Additionally, the LiDAR parameters include rotation speed, number, sensing angle, and the like of LiDAR sensors, and may be signaled from the encoding device to the decoding device.

Meanwhile, the encoding device or the decoding device may use one or multiple prediction candidate lists. When predicting the current point, the encoding device may determine which of the two prediction candidate lists to use and then may transmit the determined list index (list_index) to the decoding device. Additionally, the encoding device may determine a predictor index indicating a point to be used for prediction for the determined list and then may transmit the determined predictor index to the decoding device. Additionally, the encoding device may send the decoding device, at a higher level, the number of prediction candidate lists and the list lengths. At this time, each list may have a different length.

As described above, what is illustrated in FIG. 4 may correspond to the case of using the first prediction candidate list. Therefore, the encoding device may send the decoding device a list index indicating the first prediction candidate list, while the decoding device may generate the first prediction candidate list according to the list index and then may perform subsequent predictions.

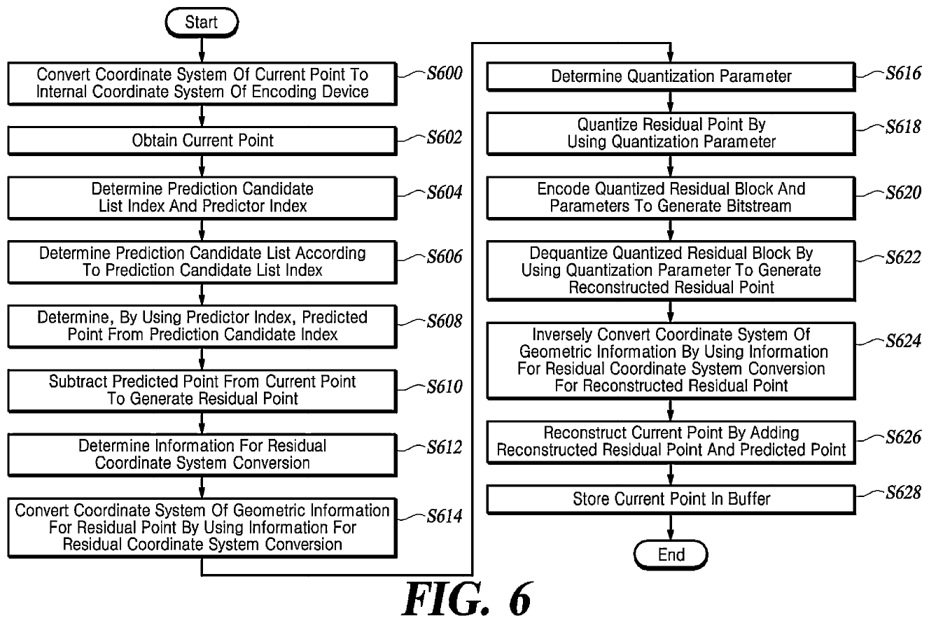

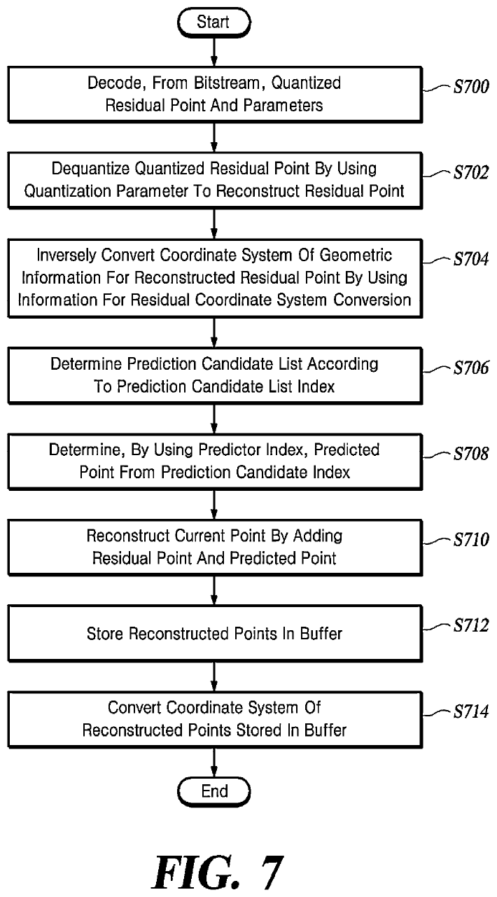

The following describes, by using the illustrations of FIGS. 6 and 7, a method performed by the encoding device or the decoding device for performing pointwise encoding or decoding of a LiDAR point cloud.

FIG. 6 is a flowchart of a method of encoding a LiDAR point cloud, according to at least one embodiment of the present disclosure.

The point cloud may have different coordinate systems depending on the output form of the LiDAR. Therefore, the coordinate system of the geometric information may need to be converted from the coordinate system of the point cloud for the current point to the coordinate system used inside the encoding device.

The encoding device converts the coordinate system of the current point to the internal coordinate system of the encoding device (S600).

The encoding device obtains the current point in the LiDAR point cloud (S602).

As described above, the encoding device may perform prediction on points included in the background among the points in the point cloud. Namely, the encoding device may skip prediction on the points included in the foreground. The encoding device may determine a flag indicating whether to apply prediction to each point and then may signal the flag to the decoding device. Additionally, if this flag is false, some of the steps below may be omitted.

The encoding device determines a prediction candidate list index and a predictor index (S604).

The encoding device determines a prediction candidate list according to the prediction candidate list index (S606). The encoding device determines the first prediction candidate list or the second prediction candidate list as the prediction candidate list according to the prediction candidate list index. The first prediction candidate list includes points similar to the current point but may be updated by using the subsequently reconstructed current point. The second prediction candidate list may be newly composed when predicting the current point. As described above, the encoding device may estimate the quantized current point and its position by using LiDAR parameters, may search for, among the reconstructed points, the points spatially closest to the quantized current point, and then may use a preset number of the searched points may be configured into a second prediction candidate list.

The encoding device determines a predicted point from the prediction candidate list by using the predictor index (S608).

The encoding device generates a residual point by subtracting the predicted point from the current point (S610).

The encoding device determines the information for the residual coordinate system conversion (S612). The encoding device determines the information for the residual coordinate system conversion to convert the coordinate system of the residual point into an efficient coordinate system in terms of encoding.

The encoding device uses the information for the residual coordinate system conversion to convert the coordinate system of the geometric information for the residual point (S614).

The encoding device determines the quantization parameter (S616).

The encoding device uses the quantization parameter to quantize the residual point (S618).

The encoding device encodes the quantized residual point and parameters to generate a bitstream (S620). Here, the parameters include the flag indicating whether to apply prediction, the prediction candidate list index, the predictor index, the quantization parameter, and the information for the residual coordinate system conversion.

The encoding device dequantizes the quantized residual point by using the quantization parameter to generate a reconstructed residual point (S622).

The encoding device inversely converts the coordinate system of the geometric information for the reconstructed residual point by using the information for the residual coordinate system conversion (S624).

The encoding device adds the reconstructed residual point and the predicted point to reconstruct the current point (S626).

As described above, the encoding device may update the first prediction candidate list by using the reconstructed current point. For example, if the current point is obtained from an object that is different from the objects containing the points included in the first prediction candidate list, the current point may be added to the foremost of the list, and the last candidate of the list may be removed. On the other hand, if the current point is obtained from the same object as one of the objects containing the points included in the first prediction candidate list, the point most similar to the current point may be removed from the list, and the current point is added to the foremost of the list. At this time, whether the points are obtained from the same object may be determined according to geometric information. For example, points in spatially proximate locations may be determined to have been obtained from the same object.

The encoding device stores the reconstructed current point in a buffer (S628).

FIG. 7 is a flowchart of a method of decoding a LiDAR point cloud, according to at least one embodiment of the present disclosure.

The decoding device decodes the quantized residual point and parameters from the bitstream (S700). Here, the parameters include the quantization parameter, the information for the residual coordinate system conversion, the prediction candidate list index, and the predictor index.

As described above, the decoding device may perform prediction on points included in the background among the points in the point cloud. Namely, the decoding device may skip prediction on the points included in the foreground. The decoding device decodes a flag indicating whether to apply prediction to each point. If the decoded flag is true, the decoding device may decode the prediction candidate list index and predictor index in addition to the quantization parameter and the information for the residual coordinate system conversion. If the decoded flag is false, some of the steps below may be omitted.

The decoding device reconstructs the residual point by dequantizing the quantized residual point by using the quantization parameter (S702).

The decoding device uses the information for the residual coordinate system conversion to inversely convert the coordinate system of the geometric information for the residual point (S704).

The decoding device determines the prediction candidate list according to the prediction candidate list index (S706). The decoding device determines the first prediction candidate list or the second prediction candidate list as the prediction candidate list according to the prediction candidate list index. The first prediction candidate list includes points similar to the current point but may be updated by using the subsequently reconstructed current point. The second prediction candidate list may be newly composed when predicting the current point. As described above, the decoding device may estimate the quantized current point and its location by using LiDAR parameters, may search for, among the reconstructed points, the points spatially closest to the quantized current point and then may use a preset number of the searched points to compose the second prediction candidate list.

The decoding device uses the predictor index to determine a predicted point from the prediction candidate list (S708).

The decoding device adds the residual point and the predicted point to reconstruct the current point (S710).

Based on a similar method to that of the encoding device, the decoding device may update the first prediction candidate list by using the reconstructed current point.

The decoding device stores the reconstructed current point in a buffer (S712).

The decoding device converts the coordinate system of the reconstructed points stored in the buffer (S714). The decoding device may convert the coordinate system exclusive to geometric information for the reconstructed points, from the internal coordinate system of the decoding device to the world coordinate system.

Although the steps in the respective flowcharts are described to be sequentially performed, the steps merely instantiate the technical idea of some embodiments of the present disclosure. Therefore, a person having ordinary skill in the art to which the present disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

202: entropy decoder
204: inverse quantizer
206: residual coordinate system inverse converter
208: adder
210: storage unit
212: coordinate system converter
214: predictor

What is claimed is:

1. A method performed by a point cloud decoding device for decoding a current point, the method comprising:
decoding, from a bitstream, a quantized residual point, a quantization parameter, a prediction candidate list index, and a predictor index;
reconstructing a residual point by dequantizing the quantized residual point by using the quantization parameter;
determining a prediction candidate list according to the prediction candidate list index;
determining a predicted point from the prediction candidate list by using the predictor index;
reconstructing the current point by adding the residual point and the predicted point; and
storing a reconstructed current point in a buffer.

2. The method of claim 1, further comprising:
decoding information for a residual coordinate system conversion from the bitstream; and
inversely converting a coordinate system of geometric information for the residual point by using the information for the residual coordinate system conversion.

3. The method of claim 1, further comprising:
converting a coordinate system of stored reconstructed points in the buffer,
wherein converting the coordinate system of the stored reconstructed points comprises:
converting a coordinate system of geometric information for a point cloud including the stored reconstructed points from an internal coordinate system of the point cloud decoding device to a world coordinate system.

4. The method of claim 1, wherein decoding the quantized residual point comprises:
with respect to a point cloud generated by a cylindrical LiDAR, decoding the quantized residual point through a total rotation angle of the cylindrical LiDAR turning about a rotational axis.

5. The method of claim 1, wherein determining the prediction candidate list comprises:
determining a first prediction candidate list or a second prediction candidate list as the prediction candidate list according to the prediction candidate list index.

6. The method of claim 5, further comprising:
updating the first prediction candidate list by using the reconstructed current point,
wherein updating the first prediction candidate list comprises:
in response to a determination that the reconstructed current point is obtained from an identical object to one of objects containing points as included in the first prediction candidate list, deleting a most similar point to the reconstructed current point from the first prediction candidate list and adding the reconstructed current point to a foremost of the first prediction candidate list.

7. The method of claim 6, wherein updating the first prediction candidate list comprises:
checking whether the points are obtained from the identical object by using geometric information of the points included in the first prediction candidate list and geometric information of the reconstructed current point.

8. The method of claim 5, further comprising:
decoding LiDAR parameters;
predicting a quantized current point and a location of the quantized current point by using the LiDAR parameters; and
generating the second prediction candidate list by using the quantized current point.

9. The method of claim 8, wherein generating the second prediction candidate list comprises:
searching closest points by distance to the quantized current point from stored reconstructed points in the buffer; and
generating the second prediction candidate list by using a preset number of searched points.

10. The method of claim 8, wherein generating the second prediction candidate list comprises:
searching points included in a previous frame for sharing common locations with and being spatially adjacent to the quantized current point; and
generating the second prediction candidate list by using a preset number of searched points.

11. A method performed by a point cloud encoding device for encoding a current point, the method comprising:
obtaining the current point;
determining a prediction candidate list index and a predictor index;
determining a prediction candidate list according to the prediction candidate list index;
determining a predicted point from the prediction candidate list by using the predictor index;
generating a residual point by subtracting the predicted point from the current point;
determining a quantization parameter;
quantizing the residual point by using the quantization parameter; and
generating a bitstream by encoding a quantized residual point, the prediction candidate list index, the predictor index, and the quantization parameter.

12. The method of claim 11, further comprising:
determining information for a residual coordinate system conversion;
converting a coordinate system of geometric information for the residual point by using the information for the residual coordinate system conversion; and
encoding the information for the residual coordinate system conversion.

13. The method of claim 12, further comprising:
generating a reconstructed residual point by dequantizing the quantized residual point with the quantization parameter;
inversely converting the coordinate system of geometric information with respect to the reconstructed residual point by using the information for the residual coordinate system conversion;
reconstructing the current point by adding the reconstructed residual point and the predicted point; and
storing a reconstructed current point in a buffer.

14. A computer-readable recording medium storing a bitstream generated by a point cloud encoding method, the point cloud encoding method comprising:
obtaining a current point;
determining a prediction candidate list index and a predictor index;
determining a prediction candidate list according to the prediction candidate list index;
determining a predicted point from the prediction candidate list by using the predictor index;
generating a residual point by subtracting the predicted point from the current point;
determining a quantization parameter;
quantizing the residual point by using the quantization parameter; and
generating a bitstream by encoding a quantized residual point, the prediction candidate list index, the predictor index, and the quantization parameter.
